(19) United States
(12) Patent Application Publication
(10) Pub. No.: US 2025/0022197 A1
(43) Pub. Date: Jan. 16, 2025

(54) PAGE RENDERING METHOD, APPARATUS AND DEVICE, AND STORAGE MEDIUM

(71) Applicant: Beijing Youzhuju Network Technology Co., Ltd., Beijing (CN)

(72) Inventor: Zongqi WEI, Beijing (CN)

(21) Appl. No.: 18/770,413

(22) Filed: Jul. 11, 2024

(30) Foreign Application Priority Data
Jul. 11, 2023 (CN) 202310848930.1

(51) Int. Cl. G06T 11/60; G06F 40/186

(52) U.S. Cl. CPC G06T 11/60; G06F 40/186

(57) ABSTRACT

The disclosure provides a page rendering method, apparatus and device, and a storage medium. The method comprises: obtaining, in response to a page rendering request for a target activity template, a template definition file corresponding to the target activity template, wherein the template definition file defines an element to be rendered; obtaining an element definition file corresponding to the element to be rendered in the template definition file; obtaining the page component and the logic function corresponding to the element to be rendered from a target storage pool; and rendering an activity configuration page corresponding to the target activity template based on the page component and the logic function corresponding to the element to be rendered.

### CROSS-REFERENCE TO RELATED APPLICATION(S)

This application claims priority to Chinese Application No. 202310848930.1 filed on Jul. 11, 2023, the disclosure of which is incorporated herein by reference in its entity.

### FIELD

The disclosure relates to the field of data processing, and in particular to a page rendering method, apparatus and device, and a storage medium.

### BACKGROUND

In the process of front-end development, page rendering is an indispensable technology. For example, when a user accesses a new page or a current page jumps to a new page, components required for page display need to be rendered into the new page.

### SUMMARY

In a first aspect, the disclosure provides a page rendering method. The method comprises:
obtaining, in response to a page rendering request for a target activity template, a template definition file corresponding to the target activity template, wherein the template definition file defines an element to be rendered;
obtaining an element definition file corresponding to the element to be rendered in the template definition file, wherein the element to be rendered comprises a page component and a logic function, and the element definition file defines a page component and a logic function corresponding to the element to be rendered;
obtaining the page component and the logic function corresponding to the element to be rendered from a target storage pool; and
rendering an activity configuration page corresponding to the target activity template based on the page component and the logic function corresponding to the element to be rendered.

In an optional implementation, the element definition file defines page components and logic functions respectively corresponding to a plurality of page types for the element to be rendered, the page rendering request carries a target page type, and obtaining the page component and the logic function corresponding to the element to be rendered from the target storage pool comprises:
obtaining, according to the target page type, the page component and the logic function corresponding to the element to be rendered from the target storage pool.

In an optional implementation, the template definition file further defines an activity template routing, and the method further comprises:
generating, based on the activity template routing, routings of activity configuration pages of a plurality of page types corresponding to the target activity template; and
correspondingly, after rendering the activity configuration page corresponding to the target activity template based on the page component and the logic function corresponding to the element to be rendered, the method further comprises:
registering a routing of the activity configuration page to a front-end routing module, wherein the front-end routing module is configured to control the activity configuration pages of the plurality of types for display based on the routings.

In an optional implementation, the method further comprises:
storing a pre-constructed page component carrying component identification into the target storage pool;
and/or, storing a logic function carrying function identification into the target storage pool.

In an optional implementation, the element definition file defines component identification and function identification corresponding to the element to be rendered, and obtaining the page component and the logic function corresponding to the element to be rendered from the target storage pool comprises:
obtaining the page component and the logic function corresponding to the element to be rendered from the target storage pool based on the component identification and the function identification corresponding to the element to be rendered that is defined in the element definition file.

In an optional implementation, a first logic function in the target storage pool is implemented based on a conduit function, the conduit function comprises synchronous conduit functions or asynchronous conduit functions, and the first logic function comprises a data validation function, a data transformation function, and/or a linkage validation function.

In an optional implementation, different elements to be rendered that are defined in the template definition file belong to the same or different workflow modules, and the workflow module is abstracted based on an activity configuration process.

In a second aspect, the disclosure provides a page rendering apparatus. The apparatus comprises:
a first obtaining module, configured to obtain, in response to a page rendering request for a target activity template, a template definition file corresponding to the target activity template, wherein the template definition file defines an element to be rendered;
a second obtaining module, configured to obtain an element definition file corresponding to the element to be rendered in the template definition file, wherein the element to be rendered comprises a page component and a logic function, and the element definition file defines a page component and a logic function corresponding to the element to be rendered;
a third obtaining module, configured to obtain the page component and the logic function corresponding to the element to be rendered from a target storage pool; and
a rendering module, configured to render an activity configuration page corresponding to the target activity template based on the page component and the logic function corresponding to the element to be rendered.

In a third aspect, the disclosure provides a non-transitory computer-readable storage medium. The computer-readable storage medium stores instructions. The instructions, when executed on a terminal device, cause the terminal device to implement the above method.

In a fourth aspect, the disclosure provides a page rendering device, comprising a memory, a processor, and a computer program stored on the memory and executable on the processor. The computer program, when executed by the processor, implements the above method.

In a fifth aspect, the disclosure further provides a computer program product. The computer program product comprises a computer program/instructions. The computer program/instructions, when executed by a processor, implement the above method.

### BRIEF DESCRIPTION OF THE DRAWINGS

The accompanying drawings herein are incorporated into the specification to form a part of the specification, illustrate embodiments conforming to the disclosure, and are used to explain the principle of the disclosure together with the specification.

In order to describe the technical solutions in the embodiments of the disclosure or in the prior art more clearly, the accompanying drawings required to be used in descriptions of the embodiments or the prior art will be briefly introduced below, and it is apparent that those of ordinary skill in the art can obtain other accompanying drawings according to these accompanying drawings without creative work.

FIG. 1 is a flowchart of a page rendering method according to an embodiment of the disclosure;

FIG. 2 is a schematic diagram of a target storage pool according to an embodiment of the disclosure;

FIG. 3 is a schematic diagram of a conduit function according to an embodiment of the disclosure;

FIG. 4 is a flowchart of form submission according to an embodiment of the disclosure;

FIG. 5 is a front-end architecture diagram according to an embodiment of the disclosure;

FIG. 6 is a structural schematic diagram of a page rendering apparatus according to an embodiment of the disclosure; and

FIG. 7 is a structural schematic diagram of a page rending device according to an embodiment of the disclosure.

### DETAILED DESCRIPTION OF EMBODIMENTS

To have a more clear understanding of the above objectives, features, and advantages of the disclosure, the solution of the disclosure is further described below. It should be noted that features of the embodiments and implementations in the disclosure can be mutually combined without conflicts.

Many specific details are elaborated in the following description to facilitate a full understanding of the disclosure, but the disclosure may also be implemented in methods different from those described here. Obviously, the embodiments in the specification are only a part rather all of the embodiments of the disclosure.

In the process of front-end development, page rendering is an indispensable technology. For example, when a user accesses a new page or a current page jumps to a new page, components required for page display need to be rendered into the new page.

In a current page rendering technology, for each activity configuration page, it is necessary to write a corresponding page component and a corresponding logic function, and the writing process is relatively complex, making it difficult to reuse. Therefore, how to significantly improve reusability of the page component and the logic function is a technical problem that urgently needs to be solved at present.

Accordingly, the embodiments of the disclosure provide a page rendering method, comprising: obtaining, in response to a page rendering request for a target activity template, a template definition file corresponding to the target activity template, wherein the template definition file defines an element to be rendered; obtaining an element definition file corresponding to the element to be rendered in the template definition file; obtaining the page component and the logic function corresponding to the element to be rendered from a target storage pool, and rendering an activity configuration page corresponding to the target activity template based on the page component and the logic function corresponding to the element to be rendered, wherein the element to be rendered comprises a page component and a logic function. It can be seen that, according to the embodiments of the disclosure, the page component and the logic function corresponding to the element to be rendered can be obtained from the target storage pool based on the element to be rendered that is defined in the template definition file, thereby the reusability of the page component and the logic function can be improved.

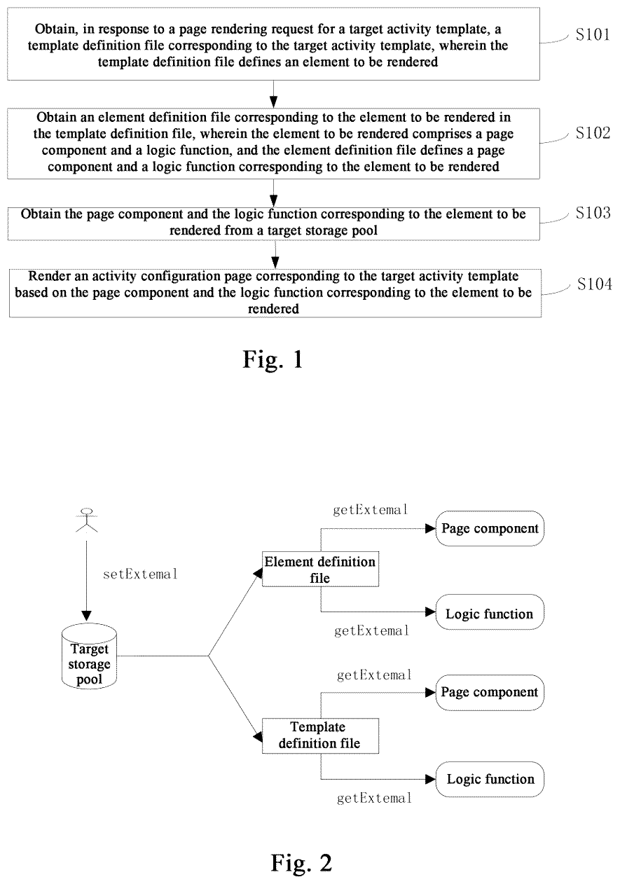

Based on this, an embodiment of the disclosure provides a page rendering method. Referring to FIG. 1, FIG. 1 is a flowchart of a page rendering method according to an embodiment of the disclosure. The method specifically includes:

S101: obtaining, in response to a page rendering request for a target activity template, a template definition file corresponding to the target activity template.

Wherein the template definition file defines an element to be rendered.

The page rendering method provided in the embodiment of the disclosure may be applied to a client. For example, the client may include a client deployed on a smartphone, a client deployed on a tablet, etc.

In the embodiment of the disclosure, the target activity template may be a standardized template pre-created based on activity information required to be configured for a target activity. A user may configure, based on the target activity template, the activity information required for the target activity. For example, the target activity may be an international e-commerce marketing activity, such as a coupon activity and a discount activity. The activity information may be, for example, activity time, an activity scope, and an activity rule corresponding to the target activity.

In practical applications, when the user browses a plurality of activity templates displayed on the current page, sending the page rendering request for the target activity template to the client of the user may be triggered by a selecting operation on the target activity template from the plurality of activity templates, such as selecting a coupon activity template, where the target activity template may be any one of the plurality of activity templates.

In the embodiment of the disclosure, when the client receives the page rendering request for the target activity, the template definition file corresponding to the target activity template may be obtained from local storage or cloud storage, where the template definition file may be used for describing activity information required for the target activity corresponding to the target activity template.

In an optional implementation, the activity information required for the target activity corresponding to the target activity template may be described using a domain-specific language (DSL), where DSL is a programming or specification language that is easy for people to understand and may be interpreted and executed by a computer, such as JSON, SQL, a regular expression, etc.

In the embodiment of the disclosure, the template definition file corresponding to the target activity template may define an element to be rendered. Specifically, the element to be rendered may comprise a page component and a logic function, where the page component refers to a visual element that is to be rendered and displayed, such as a drop-down box, a text input box, and a button control, and the logic function may be used for describing a logical relationship, an association relationship, etc. between a plurality of page components.

In an optional implementation, different elements to be rendered that are defined in the template definition file belong to the same or different workflow modules, where the workflow module may be abstracted based on an activity configuration process. For example, in the process of configuring the coupon activity, it is necessary to configure the name, time, scope, discount, etc., of the coupon activity.

The workflow module may include basic information about the activity, activity objects, an activity scope, an activity condition, an activity rule, activity display, etc.

S102: obtaining an element definition file corresponding to the element to be rendered in the template definition file.

The element to be rendered comprises a page component and a logic function, and the element definition file defines a page component and a logic function corresponding to the element to be rendered.

In the embodiment of the disclosure, since the element to be rendered is defined in the template definition file corresponding to the target activity template, the element definition file corresponding to the element to be rendered may be obtained based on the element to be rendered that is defined in the template definition file during the execution of the template definition file.

In the embodiment of the disclosure, the element definition file may be used for describing a display style or a display relationship of the element to be rendered on the activity configuration page.

S103: obtaining the page component and the logic function corresponding to the element to be rendered from a target storage pool.

In the embodiment of the disclosure, since the page component and the logic function corresponding to the element to be rendered are defined in the element definition file, the page component and the logic function corresponding to the element to be rendered may be obtained from the target storage pool based on the page component and the logic function defined in the element definition file during execution of the element definition file.

In an optional implementation, since the target storage pool may be used for storing and reading the page component and the logic function corresponding to the element to be rendered, in practical applications, the page component and/or the logic function may be pre-stored in the target storage pool, thereby facilitating to subsequently store or read the page component and the logic function from the target storage pool based on component identification and function identification. A specific storage or read method will be described in detail in subsequent embodiments, which is not repeated here.

In practical applications, page components and logic functions respectively corresponding to a plurality of page types for the element to be rendered may also be defined in the element definition file, and therefore, based on a target page type carried in the page rendering request, the page component and the logic function corresponding to the element to be rendered can be subsequently obtained from the target storage pool according to the target page type, where the page type may include a list page, a form page, a detail page, and other page types.

For example, assuming the target page type carried in the received page rendering request is a form page, a page component and a logic function corresponding to the form page type of the element to be rendered may be obtained from the target storage pool based on the form page type, thereby facilitating subsequent rendering of the form page corresponding to the target activity template based on the page component and the logic function corresponding to the form page type.

S104: rendering an activity configuration page corresponding to the target activity template based on the page component and the logic function corresponding to the element to be rendered.

In the embodiment of the disclosure, the activity configuration page is used for configuring configuration information corresponding to the target activity template, so as to subsequently generate a target activity based on the configuration information, where the activity configuration page may be, for example, a form page, and may also be a list page, a detail page, or the like.

In an optional implementation, after obtaining the page component and the logic function corresponding to the element to be rendered, the activity configuration page corresponding to the target activity template may be rendered based on a template rendering engine.

The embodiments of the disclosure provide a page rendering method, comprising: obtaining, in response to a page rendering request for a target activity template, a template definition file corresponding to the target activity template, wherein the template definition file defines an element to be rendered; obtaining an element definition file corresponding to the element to be rendered in the template definition file; obtaining the page component and the logic function corresponding to the element to be rendered from a target storage pool, and rendering an activity configuration page corresponding to the target activity template based on the page component and the logic function corresponding to the element to be rendered, wherein the element to be rendered comprises a page component and a logic function. It can be seen that, according to the embodiments of the disclosure, the page component and the logic function corresponding to the element to be rendered can be obtained from the target storage pool based on the element to be rendered that is defined in the template definition file, thereby the reusability of the page component and the logic function can be improved.

In an optional implementation, the component identification and the function identification corresponding to the element to be rendered may also be defined in the element definition file, where the component identification is a path where the corresponding page component may be read, and the function identification is a path where the corresponding logic function may be read.

For example, assuming the element definition file is named ‘element’, the element definition file ‘element’ defines component identification corresponding to an element to be rendered, such as ‘component’, and a function identification corresponding to the element to be rendered, such as ‘effect’, where the field ‘component’ is used for describing a path (i.e., the component identification) corresponding to the page component, and the field ‘effect’ is used for describing a path (i.e., the function identification) corresponding to the logic function.

In the embodiment of the disclosure, the component identification and the function identification corresponding to the element to be rendered are defined in the element definition file, thereby subsequently obtaining, based on the component identification, the page component corresponding to the component identification, and obtaining, based on the function identification, the logic function corresponding to the function identification.

In practical applications, after establishing the target storage pool, the pre-constructed page component carrying the component identification may be stored into the target storage pool, and/or the logic function carrying the function identification is stored into the target storage pool, such that when the target activity template is rendered subsequently, the page component and the logic function corresponding to the element to be rendered can be directly obtained from the target storage pool, thereby improving reusability of the page component and the logic function.

As shown in FIG. 2, FIG. 2 is a schematic diagram of a target storage pool according to an embodiment of the disclosure. In practical applications, a setExtemal function may be used for storing a page component or a logic function. When the setExtemal function is defined, two parameters are declared within the parentheses, namely, the page component and component identification corresponding to the page component, or the logic function and a function identification corresponding to the logic function, such as setExtemal (“component identification”, page component).

In the embodiment of the disclosure, since component identification and a logic function corresponding to an element to be rendered are defined in an element definition file, the page component and the logic function corresponding to the element to be rendered may be obtained from the target storage pool based on the component identification and the function identification corresponding to the element to be rendered that is defined in the element definition file during execution of the element definition file.

As shown in FIG. 2, the getExtemal function may be used for reading the page component or the logic function. When the getExtemal function is defined, one parameter is declared within the parentheses, namely, the component identification or the function identification, such as getExtemal (“component identification”).

It can be seen that in the embodiment of the disclosure, by storing the pre-constructed page component carrying the component identification into the target storage pool, and/or storing the logic function carrying the function identification into the target storage pool, when the element definition file corresponding to the element to be rendered in the template definition file is obtained subsequently, the page component and the logic function corresponding to the element to be rendered can be obtained from the target storage pool based on the component identification and the function identification corresponding to the element to be rendered that is defined in the element definition file, thereby solving the problem that the page component and the logic function in the page rendering process are difficult to use.

In practical applications, to further enhance reusability and testability of the logic function, a first logic function in the target storage pool may be implemented based on a conduit function, where the first logic function may be any one of logic functions in the target storage pool.

The conduit function is a commonly used concept in functional programming. The conduit function typically involves connecting a plurality of functions in series, such that a value is passed as a parameter to a first function, and a return value of the first function is passed as a parameter to a second function, and so on, resulting in a final return value. In the process of processing parameters using functions, if a return value of any function is an error, subsequent function execution is terminated, and an exception is thrown.

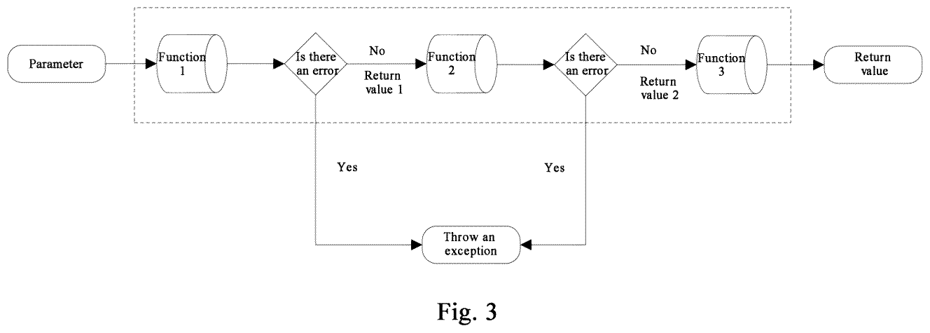

As shown in FIG. 3, FIG. 3 is a schematic diagram of a conduit function according to an embodiment of the disclosure. A specified parameter is inputted into the conduit function. First, the parameter is processed by a function 1, if a return value 1 of the function 1 is obtained, the return value 1 is passed to a function 2, and in this case, the return value 1 is processed by the function 2. If a return value 2 of the function 2 is obtained, the return value 2 is passed to a function 3. In a similar way, a final return value is obtained, namely the output of the conduit function.

In the embodiment of the disclosure, the conduit function may be utilized for connecting the plurality of logic functions of the same type in series. Different logic functions may be configured for difference points between different tenants or effective regions, thereby achieving the effect of displaying different activity templates for the different tenants or effective regions.

In the embodiment of the disclosure, the conduit function may include synchronous conduit functions or asynchronous conduit functions. The asynchronous conduit functions are different from the synchronous conduit functions in that each function in the asynchronous conduit functions is executed asynchronously.

In addition, in the embodiment of the disclosure, the conduit function is utilized for connecting the plurality of logic functions in series, and when any logic function is newly added, deleted, or replaced, operation of other logic functions cannot be affected.

In the embodiment of the disclosure, the first logic function may include a data validation function, a data transformation function, and/or a linkage validation function. The data validation function is used for validating configuration information filled into an activity configuration page, such as validating whether basic information, activity objects, etc. of a target activity are empty, or whether an activity scope of the target activity is within a limited range. The data transformation function is used for converting the currently filled configuration information into eligible information, such as converting filled activity time into a target effective region, such as corresponding time in Indonesia. The linkage validation function is used for validating an association relationship between a plurality of pieces of configuration information. For example, after determining a discount rate of 20%, when filling in a specific discount price, whether the specific discount price conforms to the above discount rate is validated.

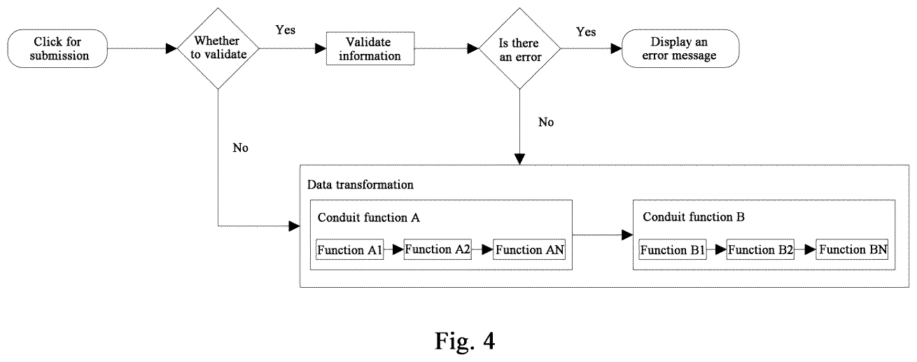

As shown in FIG. 4, FIG. 4 is a flowchart of form submission implemented based on a conduit function according to an embodiment of the disclosure. Specifically, in the scenario of form submission on an activity configuration page corresponding to a target activity template, a rendering engine automatically performs the process shown in FIG. 4.

When the user clicks a submit button, whether the activity configuration page needs to be validated is first determined. If validation is required, each piece of information to be configured on the activity configuration page is validated, such as whether basic information about a target activity is empty and whether a scope of the target activity is within a limited range. If there are errors in the information to be configured, an error prompt message is displayed on the activity configuration page to notify the user to check or modify the information to be configured.

When the user clicks the submit button, if it is determined that no validation is required, or if there are no errors after validating the information to be configured, data transformation may be performed based on a conduit function A and a conduit function B to achieve the function of obtaining the information to be configured on the activity configuration page. The conduit function A may be used for pre-filling some information to be configured into the activity configuration page. For example, when the user selects a tenant and an effective region, some information corresponding to the target activity may be pre-filled into the activity configuration page based on a manner of context information injection. The conduit function B may be used for receiving a return value of the conduit function A, and the information filled in by the user on the activity configuration page.

It can be seen that in the embodiment of the disclosure, the first logic function in the target storage pool can be implemented based on the conduit function, thereby further improving reusability and testability of the logic function. In addition, when newly adding, deleting, or replacing any one of logic functions, influences on other logic functions can be reduced.

In practical applications, an activity template routing may also be defined in the template definition file, and is used for generating routings for activity configuration pages of a plurality of page types corresponding to the target activity template. For example, when the user triggers a display request for the activity configuration pages of the plurality of page types, routings for the plurality of types of activity configuration pages corresponding to the target activity template are generated based on the activity template routing.

In the embodiment of the disclosure, the routing refers to displaying different pages or contents based on different url addresses. A task of mapping different url addresses to different contents or pages is completed by a front-end routing. Therefore, after rendering the activity configuration page corresponding to the target activity template based on the page component and the logic function corresponding to the element to be rendered, it is also necessary to register the routing of the activity configuration page into a front-end routing module.

In the embodiment of the disclosure, the front-end routing module is configured to control the display of the activity configuration pages of the plurality of types based on the routings of the activity configuration pages. That is, when receiving a switching operation of the user on the plurality of pages corresponding to the target activity template, the front-end routing module may control the activity configuration pages of the plurality of types for display based on the routings, for example, switching from the form page to the detail page and displaying the detail page.

It can be seen that in the embodiment of the disclosure, the routings of the activity configuration pages of the plurality of page types that correspond to the target activity can be generated based on the activity template routing defined in the template definition file, such that after subsequently registering the routings of the activity configuration pages to the front-end routing module, the front-end routing module can control the display of the activity configuration pages of the plurality of page types based on the routings of the activity configuration pages.

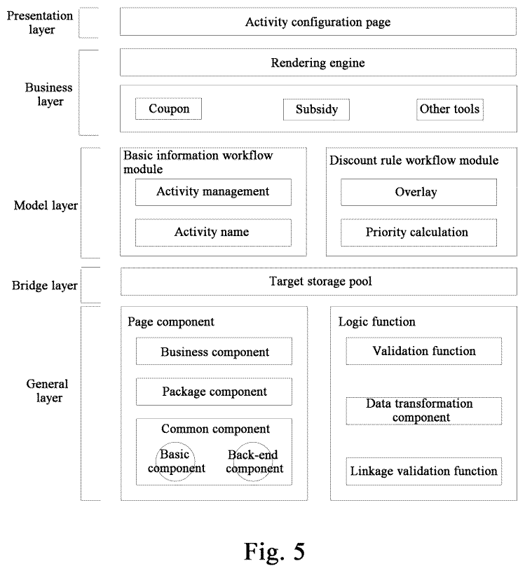

Based on the above method embodiments, the disclosure further provides a front-end architecture diagram, used for describing a process of rendering an activity configuration page corresponding to a target activity template based on a rendering element. FIG. 5 is a front-end architecture diagram according to an embodiment of the disclosure.

The front-end architecture diagram includes a general layer, a bridge layer, a model layer, a business layer, and a presentation layer. The general layer includes a plurality of page components classified based on page functionality and a plurality of logic functions classified based on function functionality.

The bridge layer is mainly used for bridging the general layer and the model layer. In practical applications, for example, based on a setExtemal function, a pre-constructed page component carrying component identification may be stored into a target storage pool, and/or a logic function carrying a function identification is stored into the target storage pool, a page component and a logic function corresponding to an element to be rendered are obtained from the target storage pool based on the setExtemal function and passed to the model layer, thereby achieving the function of bridging the general layer and the model layer.

The model layer is mainly used for describing a template definition file corresponding to the target activity template. Elements to be rendered are defined in the template definition file, and different elements to be rendered belong to the same or different workflow modules. For example, an element to be rendered that is included in a basic information workflow module includes activity management, an activity name, and activity time.

The business layer is configured with a plurality of activity templates and rendering requests. For example, the activity templates may include a coupon activity template, a subsidy activity template, etc. The rendering engine is configured to render the activity template from the business layer to the presentation layer, and the presentation layer is an activity configuration page on the client of the user.

It can be seen that in the embodiment of the disclosure, the activity configuration process can be abstracted, and the front-end architecture can be re-designed, thereby providing a testable, highly maintainable, and easily expandable front-end architecture.

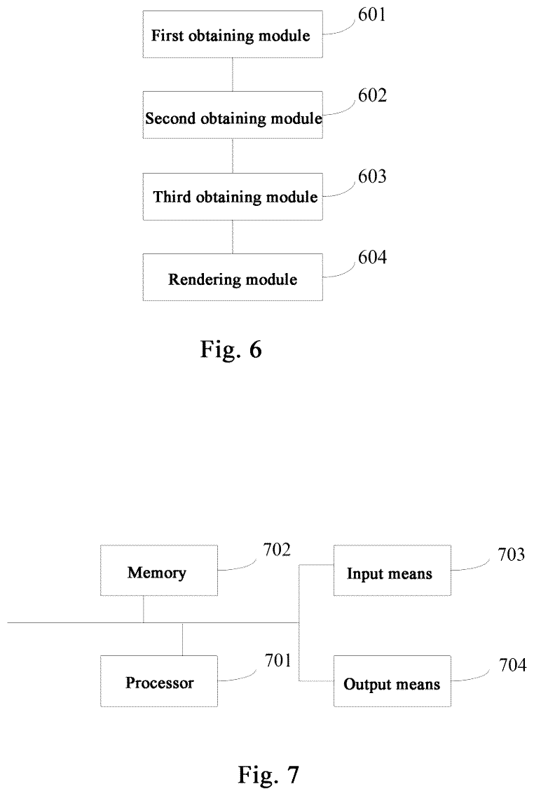

Based on the above method embodiments, the disclosure further provides a page rendering apparatus. Referring to FIG. 6, FIG. 6 is a structural schematic diagram of a page rendering apparatus according to an embodiment of the disclosure. The apparatus includes:
a first obtaining module 601, configured to obtain, in response to a page rendering request for a target activity template, a template definition file corresponding to the target activity template, wherein the template definition file defines an element to be rendered;
a second obtaining module 602, configured to obtain an element definition file corresponding to the element to be rendered in the template definition file, wherein the element to be rendered comprises a page component and a logic function, and the element definition file defines a page component and a logic function corresponding to the element to be rendered;
a third obtaining module 603, configured to obtain the page component and the logic function corresponding to the element to be rendered from a target storage pool; and
a rendering module 604, configured to render an activity configuration page corresponding to the target activity template based on the page component and the logic function corresponding to the element to be rendered.

In an optional implementation, the element definition file defines page components and logic functions respectively corresponding to a plurality of page types for the element to be rendered, the page rendering request carries a target page type, and the third obtaining module comprises:
a first obtaining submodule, configured to obtain, according to the target page type, the page component and the logic function corresponding to the element to be rendered from the target storage pool.

In an optional implementation, the template definition file further defines an activity template routing, and the apparatus further comprises:
a generation module, configured to generate, based on the activity template routing, routings of activity configuration pages of a plurality of page types corresponding to the target activity template; and
a register module, configured to register a routing of the activity configuration page to a front-end routing module, wherein the front-end routing module is configured to control the activity configuration pages of the plurality of types for display based on the routings.

In an optional implementation, the apparatus further comprises:
a storage module, configured to store a pre-constructed page component carrying component identification into the target storage pool;
and/or, store a logic function carrying function identification into the target storage pool.

In an optional implementation, the third obtaining module comprises:
a second obtaining submodule, configured to obtain the page component and the logic function corresponding to the element to be rendered from the target storage pool based on the component identification and the function identification corresponding to the element to be rendered that is defined in the element definition file.

In an optional implementation, a first logic function in the target storage pool is implemented based on a conduit function, the conduit function comprises synchronous conduit functions or asynchronous conduit functions, and the first logic function comprises a data validation function, a data transformation function, and/or a linkage validation function.

In an optional implementation, different elements to be rendered that are defined in the template definition file belong to the same or different workflow modules, and the workflow module is abstracted based on an activity configuration process.

In the page rendering apparatus provided by the embodiment of the disclosure, in response to the page rendering request for the target activity template, the template definition file corresponding to the target activity template is obtained, where the element to be rendered is defined in the template definition file; the element definition file corresponding to the element to be rendered in the template definition file is obtained; and the page component and the logic function corresponding to the element to be rendered are obtained from the target storage pool, and the activity configuration page corresponding to the target activity template is rendered based on the page component and the logic function corresponding to the element to be rendered, where the page component and the logic function corresponding to the element to be rendered are defined in the element definition file. It can be seen that, according to the embodiment of the disclosure, the page component and the logic function corresponding to the element to be rendered can be obtained from the target storage pool based on the element to be rendered that is defined in the template definition file, thereby the reusability of the page component and the logic function can be improved.

In addition to the above method and apparatus, an embodiment of the disclosure further provides a non-transitory computer-readable storage medium. The computer-readable storage medium stores instructions. The instructions, when executed on a terminal device, cause the terminal device to implement the page rendering method according to the embodiments of the disclosure.

An embodiment of the disclosure further provides a computer program product. The computer program product includes a computer program/instructions. The computer program/instructions, when executed by a processor, implement the page rendering method according to the embodiments of the disclosure.

In addition, an embodiment of the disclosure further provides a page rendering device.

Referring to FIG. 7, the device may comprises:
a processor 701, a memory 702, an input means 703, and an output means 704. There may be one or more processors 701 in the page rendering device. One processor in FIG. 7 is used as an example. In some embodiments of the disclosure, the processor 701, the memory 702, the input means 703, and the output means 704 may be connected through a bus or other methods. Bus connection is used as an example in FIG. 7.

The memory 702 may be configured to store software programs and modules. The processor 701 performs various functional applications and data processing of the page rendering device by running the software programs and the modules stored in the memory 702. The memory 702 may mainly include a program storage area and a data storage area, where the program storage area may store an operating system, an application program needed by at least one function, etc. In addition, the memory 702 may include a high-speed random access memory, and may further include a non-volatile memory, such as at least one magnetic disk storage device, a flash memory, or another volatile solid-state storage device. The input means 703 may be configured to receive inputted number or character information and generate signal inputs relevant to user settings and function control of the page rendering device.

Specifically, in the embodiment, the processor 701 may load executable files corresponding to processes of one or more applications into the memory 702 according to following instructions, and the processor 701 executes the applications stored in the memory 702, thereby implementing various functions of the above page rendering device.

It should be noted that herein, relational terms such as “first” and “second” are used only to distinguish one entity or operation from another and do not necessarily require or imply any actual relationship or order between these entities or operations. In addition, terms “comprise”, “include”, or any other variations thereof are intended to cover non-exclusive inclusion, and therefore a process, a method, an object, or a device including a series of elements not only includes those elements but also includes other elements not clearly listed, or further includes inherent elements for the process, the method, the object, or the device. In the absence of further restrictions, an element specified by the phrase “including a . . . ” does not exclude the existence of other identical elements in the process, the method, the product, or the device that includes the element.

The above contents are merely specific implementations of the disclosure, such that those skilled in the art can understand or implement the disclosure. More modifications for these embodiments are apparent to those skilled in the art, and general principles defined herein may be implemented in other embodiments without departing from the spirit or scope of the disclosure. Therefore, the disclosure will not be limited by these embodiments described herein but is required to conform to a widest scope consistent with the principles and novel characteristics disclosed herein.

I/We claim:

1. A page rendering method, comprising:
obtaining, in response to a page rendering request for a target activity template, a template definition file corresponding to the target activity template, wherein the template definition file defines an element to be rendered;
obtaining an element definition file corresponding to the element to be rendered in the template definition file, wherein the element to be rendered comprises a page component and a logic function, and the element definition file defines a page component and a logic function corresponding to the element to be rendered;
obtaining the page component and the logic function corresponding to the element to be rendered from a target storage pool; and
rendering an activity configuration page corresponding to the target activity template based on the page component and the logic function corresponding to the element to be rendered.

2. The method according to claim 1, wherein the element definition file defines page components and logic functions respectively corresponding to a plurality of page types for the element to be rendered, the page rendering request carries a target page type, and obtaining the page component and the logic function corresponding to the element to be rendered from the target storage pool comprises:
obtaining, according to the target page type, the page component and the logic function corresponding to the element to be rendered from the target storage pool.

3. The method according to claim 1, wherein the template definition file further defines an activity template routing, and the method further comprises:
generating, based on the activity template routing, routings of activity configuration pages of a plurality of page types corresponding to the target activity template; and
correspondingly, after rendering the activity configuration page corresponding to the target activity template based on the page component and the logic function corresponding to the element to be rendered, the method further comprises:
registering a routing of the activity configuration page to a front-end routing module, wherein the front-end routing module is configured to control the activity configuration pages of the plurality of types for display based on the routings.

4. The method according to claim 1, further comprising:
storing a pre-constructed page component carrying component identification into the target storage pool;
and/or, storing a logic function carrying function identification into the target storage pool.

5. The method according to claim 4, wherein the element definition file defines component identification and function identification corresponding to the element to be rendered, and obtaining the page component and the logic function corresponding to the element to be rendered from the target storage pool comprises:
obtaining the page component and the logic function corresponding to the element to be rendered from the target storage pool based on the component identification and the function identification corresponding to the element to be rendered that is defined in the element definition file.

6. The method according to claim 1, wherein a first logic function in the target storage pool is implemented based on a conduit function, the conduit function comprises synchronous conduit functions or asynchronous conduit functions, and the first logic function comprises a data validation function, a data transformation function, and/or a linkage validation function.

7. The method according to claim 1, wherein different elements to be rendered that are defined in the template definition file belong to the same or different workflow modules, and the workflow module is abstracted based on an activity configuration process.

8. A non-transitory computer-readable storage medium, storing instructions, wherein the instructions, when executed on a terminal device, cause the terminal device to:
obtain, in response to a page rendering request for a target activity template, a template definition file corresponding to the target activity template, wherein the template definition file defines an element to be rendered;
obtain an element definition file corresponding to the element to be rendered in the template definition file, wherein the element to be rendered comprises a page component and a logic function, and the element definition file defines a page component and a logic function corresponding to the element to be rendered;
obtain the page component and the logic function corresponding to the element to be rendered from a target storage pool; and
render an activity configuration page corresponding to the target activity template based on the page component and the logic function corresponding to the element to be rendered.

9. The medium according to claim 8, wherein the element definition file defines page components and logic functions respectively corresponding to a plurality of page types for the element to be rendered, the page rendering request carries a target page type, and the instructions causing the terminal device to obtain the page component and the logic function corresponding to the element to be rendered from the target storage pool further cause the terminal device to:
obtain, according to the target page type, the page component and the logic function corresponding to the element to be rendered from the target storage pool.

10. The medium according to claim 8, wherein the template definition file further defines an activity template routing, and the instructions further causes the terminal device to:
generate, based on the activity template routing, routings of activity configuration pages of a plurality of page types corresponding to the target activity template; and
correspondingly, after rendering the activity configuration page corresponding to the target activity template based on the page component and the logic function corresponding to the element to be rendered, the instructions further cause the terminal device to:
register a routing of the activity configuration page to a front-end routing module, wherein the front-end routing module is configured to control the activity configuration pages of the plurality of types for display based on the routings.

11. The medium according to claim 8, the instructions further causing the terminal device to:
store a pre-constructed page component carrying component identification into the target storage pool;
and/or, store a logic function carrying function identification into the target storage pool.

12. The medium according to claim 11, wherein the element definition file defines component identification and function identification corresponding to the element to be rendered, and the instructions causing the terminal device to obtain the page component and the logic function corresponding to the element to be rendered from the target storage pool further cause the terminal device to:
obtain the page component and the logic function corresponding to the element to be rendered from the target storage pool based on the component identification and the function identification corresponding to the element to be rendered that is defined in the element definition file.

13. The medium according to claim 8, wherein a first logic function in the target storage pool is implemented based on a conduit function, the conduit function comprises synchronous conduit functions or asynchronous conduit functions, and the first logic function comprises a data validation function, a data transformation function, and/or a linkage validation function.

14. The medium according to claim 8, wherein different elements to be rendered that are defined in the template definition file belong to the same or different workflow modules, and the workflow module is abstracted based on an activity configuration process.

15. A page rendering device, comprising a memory, a processor, and a computer program stored on the memory and executable on the processor, wherein the computer program, when executed by the processor, causes the processor to:
obtain, in response to a page rendering request for a target activity template, a template definition file corresponding to the target activity template, wherein the template definition file defines an element to be rendered;
obtain an element definition file corresponding to the element to be rendered in the template definition file, wherein the element to be rendered comprises a page component and a logic function, and the element definition file defines a page component and a logic function corresponding to the element to be rendered;
obtain the page component and the logic function corresponding to the element to be rendered from a target storage pool; and
render an activity configuration page corresponding to the target activity template based on the page component and the logic function corresponding to the element to be rendered.

16. The device according to claim 15, wherein the element definition file defines page components and logic functions respectively corresponding to a plurality of page types for the element to be rendered, the page rendering request carries a target page type, and the computer program causing the processor to obtain the page component and the logic function corresponding to the element to be rendered from the target storage pool further cause the processor to:
obtain, according to the target page type, the page component and the logic function corresponding to the element to be rendered from the target storage pool.

17. The device according to claim 15, wherein the template definition file further defines an activity template routing, and the computer program further causes the processor to:
generate, based on the activity template routing, routings of activity configuration pages of a plurality of page types corresponding to the target activity template; and
correspondingly, after rendering the activity configuration page corresponding to the target activity template based on the page component and the logic function corresponding to the element to be rendered, the instructions further cause the terminal device to:
register a routing of the activity configuration page to a front-end routing module, wherein the front-end routing module is configured to control the activity configuration pages of the plurality of types for display based on the routings.

18. The device according to claim 15, the computer program further causing the processor to:
store a pre-constructed page component carrying component identification into the target storage pool;
and/or, store a logic function carrying function identification into the target storage pool.

19. The device according to claim 18, wherein the element definition file defines component identification and function identification corresponding to the element to be rendered, and the computer program causing the processor to obtain the page component and the logic function corresponding to the element to be rendered from the target storage pool further cause the processor to:
obtain the page component and the logic function corresponding to the element to be rendered from the target storage pool based on the component identification and the function identification corresponding to the element to be rendered that is defined in the element definition file.

20. The device according to claim 15, wherein a first logic function in the target storage pool is implemented based on a conduit function, the conduit function comprises synchronous conduit functions or asynchronous conduit functions, and the first logic function comprises a data validation function, a data transformation function, and/or a linkage validation function.
